(19) United States
(12) Patent Application Publication
(10) Pub. No.: US 2003/0177076 A1
(43) Pub. Date: Sep. 18, 2003

(54) System and method for directing product information to a user over a network using a server

(76) Inventors: Robert J. Might, Great Falls, VA (US); Bret A. Harris, South Riding, VA (US); Corey M. Balon, Herndon, VA (US); Matthew S. Plummer, Leesburg, VA (US); John Lear, Purcellville, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/383,147

(22) Filed: Mar. 6, 2003

Related U.S. Application Data
(60) Provisional application No. 60/364,984, filed on Mar. 15, 2002.

(51) Int. Cl. G06F 17/60

(52) U.S. Cl. 705/28

(57) ABSTRACT

A system and method for directing information relating to a product offering of a retailer to a user over a network. Data relating to the products offered by a brick and mortar retailer is acquired from sources other than the brick and mortar retailer thereby creating a presence on the network for the brick and mortar retailer without requiring action on its part. A brick and mortar retailer may further associate an electronic media advertisement with the data relating to the products it offers for sale. A user may initiate a search request for products offered by a brick and mortar retailer meeting consumer-selected criteria.

### CROSS REFERENCE TO RELATED APPLICATIONS

This application claims priority under 35 U.S.C. § 119(e) from provisional application No. 60/364,984 filed Mar. 15, 2002. The No. 60/364,984 provisional application is incorporated by reference herein, in its entirety, for all purposes.

### FIELD OF THE INVENTION

This invention relates generally to electronic advertising over a network. More particularly, the present invention is a method and apparatus for permitting “brick and mortar” retailers to advertise goods and services over a network so as to permit such retailers to compete in a cost effective manner with web-based retailers.

### BACKGROUND OF THE INVENTION

For all retailers of goods and services, the challenge is to acquire and keep customers. Historically, the primary means of customer acquisition has been advertising. Before the Internet, the primary vehicles for retail advertisements were print media, television, and radio.

The development of the Internet not only created a new media, but a new type of retailer, the E-merchant. In its purest manifestation, an E-merchant has no storefront, little inventory, and few employees. Orders are taken electronically, processed electronically, paid for electronically, and shipped by third-party fulfillment houses. For the E-merchant, the Web offers not only a place to create a virtual store, but a means to advertise the business of the virtual store and the goods and services offered by the E-merchant. Moreover, search engines allow consumers to find E-merchants of all sizes, to learn about prices, and to compare terms.

E-merchants compete with “brick and mortar retailers” (retailers who sell from physical locations and interact with customer in person) for sales. The problem is that today the Internet does not offer the brick and mortar retailer the tools to compete effectively with E-merchants on the latter's turf. Unless a brick and mortar retailer wants to create and manage a website (or pay a third party to operate such a site), there are few options available to a brick and mortar retailer to gain Web presence. Even if a brick and mortar retailer were to elect to invest in a Web site, the brick and mortar retailer cannot be certain that the consumers that are its most likely customers will find the site among the myriad of E-merchants offering similar goods and services.

A number of Web sites offer the equivalent of the “Yellow Pages”. A brick and mortar retailer may list its name, contact information, and a general statement of the goods and services it offers. For example, a brick and mortar retailer may be listed under the general heading “Home and Garden” and then under “Appliances”. The same brick and mortar retailer may be listed under the heading “Home and Garden” and under the subheading “Housewares.” The brick and mortar retailer can be “found” but nothing is known about the brands it carries, its prices, or its special offerings. As a result, static directories do not provide the brick and mortar retailer an effective means to compete with the E-merchant.

The standard means for a local brick and mortar retailer to reach local consumers today is by advertising in the yellow pages and the local papers. Newspaper and other print media advertising is expensive, and, for the small brick and mortar retailer, of questionable cost effectiveness. Even if a brick and mortar retailer could afford to place such an ad, there is no guarantee that a consumer will see it. The consumer must manually parse the local newspaper or search the yellow pages to find ads relating to whatever he or she is shopping for. While this approach can be successful, it does not put the brick and mortar retailer in a position to compete effectively with an E-merchant in the same market.

Launching a Web site can help level the playing field between a brick and mortar retailer and an E-merchant. The problem is first one of resources. The brick and mortar retailer is paying to operate both a real and a virtual store. More importantly, a brick and mortar retailer's Web site may make the competition more equal, but does nothing to give the brick and mortar retailer an advantage over its E-merchant competitor. Search engines will find multiple sites, including, perhaps, the site of the brick and mortar retailer. The information returned to the consumer is not organized, not specific, and can be voluminous. The consumer is still required to sort the information it receives. The brick and mortar retailer with a Web site can only hope that the consumer sees its message.

What is desired is a system whereby brick and mortar retailers can direct electronic media advertising to consumers who want or need to shop at a brick and mortar store without requiring the brick and mortar retailer to incur the expense of establishing a Web site. Such a system would allow brick and mortar retailers to advertise and offer price and sales information as they would in printed media and allow a consumer to initiate a search request for goods and services offered by brick and mortar retailers meeting consumer-selected product characteristics within the consumer's selected geographic area. Additionally, the system would minimize the product information that a brick and mortar retailer is required to upload and manage by taking advantage of the existing systems used by manufacturers, distributors, and brick and mortar retailers to manage products and track sales.

### SUMMARY OF THE INVENTION

An embodiment of the present invention is a system and method for directing information to consumers relating to products offered by a brick and mortar retailer. For the purposes of this Application, “product” includes both tangible goods and services. The brick and mortar retailer may elect to display an electronic media advertisement (EMA) comprising product information and price information. The information is directed to a consumer in response to a search request initiated by the consumer.

It is therefore an aspect of the present invention to acquire information relating to the products offered for sale by a brick and mortar retailer and to store information relating to those products in a central datastore without having to obtain that information from a brick and mortar retailer.

It is another aspect of the present invention to acquire information relating to the characteristics of a product from the manufacturers, distributors, and retailers and to store such information, or links to such information, in a central datastore.

It is another aspect of the present invention to acquire information relating to the characteristics of a product from retailers who provide that product or from product directories and to store such information, or links to such information, in a central datastore.

It is still another aspect of the present invention to allow a brick and mortar retailer means to create an EMA in a simple and cost effective manner.

It is a further aspect of the present invention to provide a brick and mortar retailer a means to direct EMAs to consumers without the brick and mortar retailer incurring the expense of creating, operating, and maintaining a Web site.

It is yet another aspect of the present invention to allow a brick and mortar retailer to include in an EMA for a particular product offered by the brick and mortar retailer the manufacturer's suggested retail price, the brick and mortar retailer's normal price, and the brick and mortar retailer's current price of that product.

It is yet another aspect of the present invention to allow a brick and mortar retailer to include in an EMA for a service product offered by the brick and mortar retailer the hourly rate and/or unit price for that service product.

It is another aspect of the present invention to provide a brick and mortar retailer means to update price information of the products they sell.

It is another aspect of the present invention to provide a consumer the means to initiate a search request of the central datastore against product characteristics associated with a particular product categories as selected by a consumer from a product characteristics drop-down list of characteristics for that product type within a geographic area selected by the consumer.

It is yet another aspect of the present invention to search an EMA for product characteristics, to identify a product model through the identified product characteristic, associate the product model with unique identifiers such as the product UPC, and to determine if the brick and mortar retailer has price information for that identified product.

It is still a further aspect of the present invention to allow a consumer to create a preference folder of his or her favorite brick and mortar retailers, geographic locations, shopping preferences, and other information and to store the preference folder in a consumer datastructure.

It is a further aspect of the present invention to alert a consumer when a brick and mortar retailer selected by the consumer issues a new EMA or a new price list.

It is yet another aspect of the present invention to allow a consumer to determine if a brick and mortar retailer has the product in inventory and, if so, to reserve it.

It is still another aspect of the present invention to permit a consumer to transfer selected EMAs and the results of search requests to a portable electronic device.

These and other aspects of the present invention will become apparent from a review of the general and detailed descriptions that follow.

An embodiment of the present invention is a system and method for directing information to consumers relating to products offered by a brick and mortar retailer. Information relating to products offered by a brick and mortar retailer is obtained from any one of a number of sources. By way of example and not as a limitation, such information may be obtained from the brick and mortar retailer, from a manufacturer, from a distributor, and from public and private sources. Thus, product information of a brick and mortar retailer may be directed to a consumer with little or no direct input from the brick and mortar retailer. In addition, a brick and mortar retailer may elect to direct to consumers an electronic media advertisement (EMA) comprising product information and price information.

Product information is directed to a consumer in response to a search request initiated by the consumer. In an embodiment, an electronic media server is linked to a central datastore comprising a data structure associated with a brick and mortar retailer (a BMR data structure). The BMR data structure holds information related to the brick and mortar retailer's identity, products, prices, and EMAs. In an embodiment, the BMR data structure holds a location identifier where information may be located and accessed. A consumer searches the central datastore for retailers that offer a particular product by initiating a search request. The electronic media server manages the search request through the use of a product hierarchy. To illustrate, the top of the product hierarchy is a product family (for example, appliances, transportation, clothing, insurance, and services). At the second tier of this hierarchy, each family is divided into product categories. For example, within the product family “appliances” are the product categories refrigerators, washers, dryers, and dishwashers. Within the product family “services” are the product categories plumbing services and dental services. Within the product family “insurance” are the product categories life insurance, home insurance and automobile insurance. The last level of the product hierarchy is the product characteristics associated with each product within a product category. Using a user access device (“UAD”), a consumer sends a search request to the electronic media server, which responds by searching the central datastore. The search request incorporates the product family, product category, and product characteristics selected by the consumer. In an alternate embodiment, the search request is limited to a geographic area determnined by zip code and a specified distance outside that zip code. The electronic media server searches the central datastore for products that match at least a portion of the product characteristics selected by the consumer. The results of the search request are displayed on the UAD in the form of a match list.

In an embodiment, the UAD is a general purpose computer, but the invention is not so limited. However, any device capable of accessing a network, interacting with a server, and displaying a match list can be used to perform the tasks assigned to the UAD. For example, and not as a limitation, a UAD may be a personal digital assistant connected to a LAN or a wireless telephone that accesses the Internet through a wireless gateway.

In another embodiment, when a brick and mortar retailer elects to store an EMA on the central datastore, a notation is made in the central datastore and in the match list presented to the consumer in response to a search request. The match list returned in response to a search request initiated by a consumer is displayed on the user access device in accordance with a priority scheme managed by an electronic media server. In this embodiment, the priority scheme causes those brick and mortar retailers with EMAs to be displayed ahead of those without EMAs. Within the group of brick and mortar retailers with EMAs, those brick and mortar retailers that have provided pricing information are displayed ahead of those without pricing information. Within the group of EMAs with pricing, those EMAs that include special pricing are displayed ahead of those without special pricing. As will be apparent to those skilled in the art, other priority schemes, such as a priority scheme that displays EMAs based on the date an EMA was updated, may be utilized without departing from the scope of the present invention.

In an embodiment of the present invention, the consumer may transfer the results of a search request and selected EMAs to a portable electronic device (PED). By way of example, the PED may be a laptop computer, a cellular phone, or a personal digital assistant. However, this is not meant as a limitation. As will be apparent to those skilled in the art, any portable device that can accept and display digital data may be used in this embodiment without departing from the scope of the present invention.

In the present invention, the product information is accessible over a network. In the preferred embodiment, this network is the Internet. This, however, is not meant as a limitation since any network (wired or wireless or combination thereof) will be satisfactory to execute the tasks of the present invention.

### BRIEF DESCRIPTION OF THE DRAWINGS

FIG. 1 illustrates the basic architecture of the electronic media advertising system according to an embodiment of the present invention.

FIGS. 2A and 2B illustrated a flow of the creation of an EMA using an Ad Tool according to an embodiment of the invention.

FIG. 3 illustrates a flow of an access process according to an embodiment of the present invention.

FIG. 4A and FIG. 4B illustrate a business site according to an embodiment of the present invention.

FIG. 5 illustrates a consumer site according to an embodiment of the present invention.

### DETAILED DESCRIPTION OF THE INVENTION

An embodiment of the present invention is a system and method for directing information to consumers relating to products offered by a brick and mortar retailer. The brick and mortar retailer may elect to display an electronic media advertisement (EMA) comprising product information and price information. The information is directed to a consumer in response to a search request initiated by the consumer.

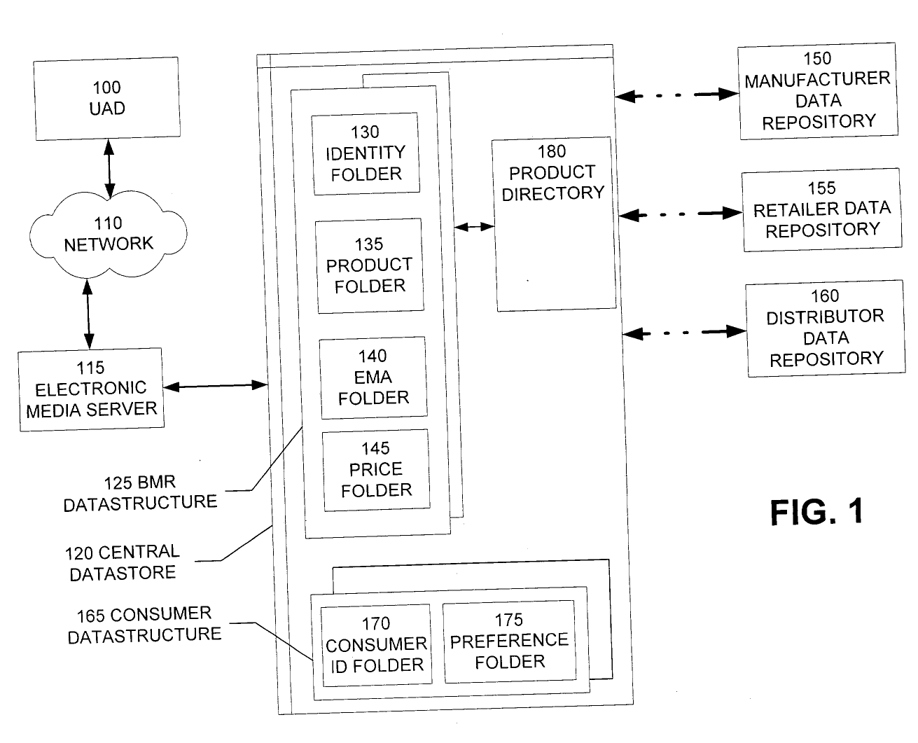

FIG. 1 illustrates the basic architecture of the electronic media advertising system according to an embodiment of the present invention. A user access device UAD 100, accesses a network, in this embodiment, the Internet 110. In this embodiment, the UAD depicted in FIG. 1 is a general-purpose computer. However, this is not meant as a limitation. Any device capable of accessing a network, interacting with a server, and displaying a match list (described below) can be used to perform the tasks assigned to the UAD. For example, and not as a limitation, a UAD may be a PED such as a laptop computer or a personal data assistant connected to a LAN or a wireless telephone that accesses the Internet through a wireless gateway. Similarly, the network depicted in FIG. 1 is the Internet, but the invention is not so limited. The network may comprise a plurality of interconnected networks, wired and wireless. By way of illustration and not as a limitation, in an alternate embodiment of the present invention the network is a LAN operated at a retail shopping mall.

The UAD is connected via the network to an electronic media server 115. It should be noted that it is anticipated that many UADs will be accessing the electronic media server simultaneously and that multiple electronic media servers may be required to provide the functions of the single electronic media server depicted here in order to achieve scalable performance.

The electronic media server 115 is linked to central datastore 120. Central datastore 120 comprises data used by the electronic media server 115. In this embodiment, each brick and mortar retailer is associated with a BMR datastructure 125 comprising an identity folder 130, a product folder 135, an EMA folder 140, and a price folder 145. A folder may contain data or a location identifier where that data may be located.

The identity folder 130 comprises identity data about a particular brick and mortar retailer. In an embodiment of the present invention, identity data comprises the name, address and contact information of the brick and mortar retailer and the brick and mortar retailer's outlets, the product categories offered by the brick and mortar retailer, and, if the brick and mortar retailer is registered with the electronic media server 115. If the brick and mortar retailer is registered with the electronic media server 115, identity data further comprises data that permits the brick and mortar retailer to logon to the electronic media server 115.

The product folder 135 comprises the products known to be offered by the brick and mortar retailer each associated with one or more product descriptors. Each product is assigned a unique product identifier. In another embodiment, the unique product identifier associates a particular product with a product identifier assigned by a manufacturer. A product descriptor comprises product characteristics of each product carried the brick and mortar retailer to which the product folder 135 pertains. By way of illustration and not as a limitation, the product characteristics associated with a refrigerator include the name of the manufacturer, the UPC, its dimensions, its color, and its energy efficiency rating. The data associated with a lawn mower include the name of the manufacturer, its UPC, the cutting swath, whether it bags, mulches or drops clippings, and the horsepower of the engine.

In an embodiment of the present invention, the product folder 135 is, populated by obtaining data directly from a manufacturer data repository 150 thereby allowing the most recent manufacturer data and products to be represented. This approach is efficient and cost effective, but it is not the only means of acquiring the data relating to products. The products of a brick and mortar retailer identified in the product folder 135 may be obtained directly from data maintained by the brick and mortar retailer in a retailer data repository 155. In still another embodiment, the products offered by a brick and mortar retailer is obtained from a distributor data repository 160. In yet another embodiment, the products offered by a brick and mortar retailer are obtained from a manually searching public and private sources. As will be apparent to those skilled in the art, any means or combination of means may be used to populate the product folder without departing from the scope of the present invention. Further, while only data repositories 150, 155, and 160 are illustrated in FIG. 1, this is not meant as a limitation. As will be appreciated by those skilled in the art, any number of manufacturer, retailer, and distributor data repositories may be accessible to central datastore 120 without departing from the scope of the present invention.

In the context of a service, the manufacturer data repository 150 represents a franchiser or other source of such services. By way of illustration, a manufacturer data repository 150 of a national insurance carrier would comprise data relating to the policies offered by the insurer. The distributor data repository 160 represents a directory of agents that offer the insurance of the national insurance carrier.

In an embodiment of the present invention, data stored at data repositories 150, 155, and 160 are downloaded and stored at central datastore 120. In another embodiment, an index of the data stored at data repositories 150, 155, and 160 is maintained in the product folder 135 and data required by electronic media server 115 is accessed when needed. In yet another embodiment, the electronic media server 115 polls a data repository. In still another embodiment, the electronic media server 115 responds to a prompt sent by a data repository.

As noted, the product folder 135 comprises the products known to be offered by the brick and mortar retailer. Each product is assigned a unique product identifier. With respect to products, the product identifier is also associated with a product identifier created by the product manufacturer. The manufacturer data repository 150 comprises data relating to products that have been assigned a unique product identifier by the manufacturer of those products. Some manufacturers use a Universal Product Code (“UPC”) while other manufacturers may elect to use the EAN Article Numbering Code. (For the purpose of this specification, references to the UPC encompass the EAN Article Numbering Code and their various versions).

A product directory 180 comprises a directory of all of the products offer by all brick and mortar retailers for which a BMR datastructure 125 is maintained on central datastore 120. In an embodiment, product directory 180 comprises a common descriptive name, a product identifier, a manufacturer assigned product identifier (such as a UPC), a means for associating each product with at least one brick and mortar retailer, and a notation indicating whether the brick and mortar retailer has uploaded an EMA to the EMA folder 140. In another embodiment, the product directory 180 polls the central datastore 120 for new or deleted BMR datastructures and for changes in the content of each BMR datastructure. In an alternate embodiment, the electronic media server 115 causes changes in the central datastore 120 relating to the content of the product directory 180 to be directed to the product directory 180. In yet another embodiment, each brick and mortar retailer is assigned a BMR identifier and at least one BMR identifier is associated with each product in product directory 180.

The consumer datastructure 165 comprises information about consumers. In an embodiment, a consumer is offered the opportunity to log into the electronic media server 115, or, if the consumer has not already established an identity on the electronic media server 115, to register such an identity. Login and authentication information are stored in consumer ID folder 170 within consumer data structure 165. Once a consumer has established an identity with electronic media server 115 (that is, the consumer is a “registered consumer”), the registered consumer may elect to setup a preference folder 175. The preference folder 175 retains the consumer's favorite shopping locations by zip code, favorite brick and mortar retailers, and products of interest.

Referring again to FIG. 1, EMA folder 140 comprises the electronic media advertisements (EMAs) of the brick and mortar retailer to which BMR data structure 125 pertains. A typical EMA comprises the brick and mortar retailer's location, hours of operation, phone number and a brief description of the products the brick and mortar retailer carries. A more detailed EMA further comprises details regarding particular products that a brick and mortar retailer carries, including product graphics, and pricing information for the products. An even more detailed EMA comprises a price list, or a link to a price list, of selected products.

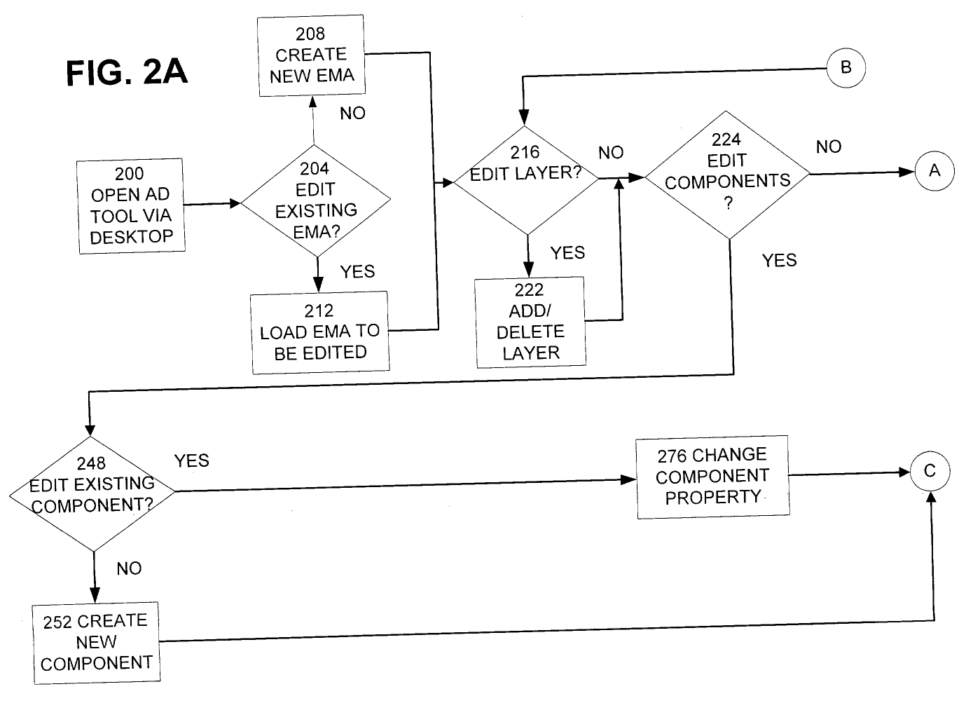

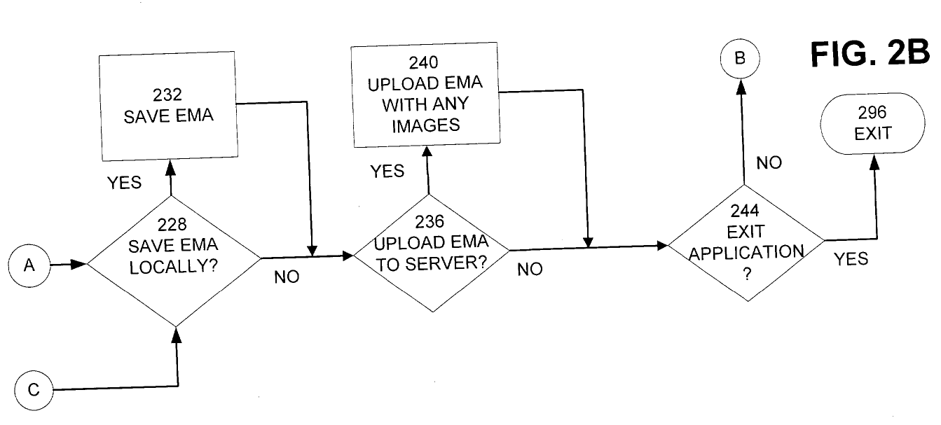

Referring to FIGS. 2A and 2B, a flow of the creation of an EMA using an Ad Tool according to an embodiment of the invention is illustrated.

A brick and mortar retailer opens the Ad Tool 200, and elects to either open an existing EMA or create a new EMA 204. If creating a new EMA is selected 208, the brick and mortar retailer starts with a blank EMA, uses a copy of an existing EMA, or uses a template. When opening an existing EMA 212, the brick and mortar retailer opens an EMA previously saved locally or downloaded from the EMA folder (FIG. 1, 140) of the brick and mortar retailer.

According to an embodiment of the present invention, an EMA comprises one or more layers, each of which comprises a set of components. In this embodiment, a component is a fixed portion of a layer. Each component comprises one or more properties. By way of illustration and not as a limitation, a component may have an image property, a size property, a position property, a text property and a background property. Additionally, the image property and the text property may comprise a link property.

A link property causes a component to be dynamic. A link property may comprise a link to a product image stored in the product folder (FIG. 1, 135) or stored in another data repository. If the information to which the link is directed changes, the value of the link property also changes. By way of illustration, if a link property relates to a price in the price folder (FIG. 1, 145) and the price value in price folder 145 is changed, the price change is also automatically reflected in the value of the link property. In another example, a text property comprises a link to a data repository comprising store addresses. In yet another embodiment, the store addresses selected by the link are determined by the search criteria selected by the consumer (discussed in detail below).

In an embodiment of the present invention, the background property is selected from a transparent background and a colored background. Layers are stacked on top of each other to complete the EMA. The background quality of a component in each layer will determine the visible portion of the completed EMA.

The brick and mortar retailer selects whether to edit a layer 216. If edit layers is selected, the brick and mortar retailer adds or deletes a layer 220. If the brick and mortar retailer does not desire to edit layers, or if the brick and mortar retailer has finished editing layers, the brick and mortar retailer is offered the opportunity to edit a component 224. If the brick and mortar retailer does not elect to edit components, the brick and mortar retailer is offered the opportunity to save the EMA locally 228 and the EMA is saved 232. In an embodiment, the EMA is saved as an XML document. However, this not meant as a limitation. Whether or not the EMA is save locally, the brick and mortar retailer is offered the opportunity to upload the EMA to the EMA folder (FIG. 1, 140). If uploading is elected, the EMA is uploaded to the EMA folder 240. At this point, the brick and mortar retailer determines whether to exit the application 244. If the decision is made to exit, the brick and mortar retailer exits the Ad Tool 296. If the decision is not to exit, the application returns to the edit layer decision node 216.

If the decision is made to edit a component 224, a decision is made whether to edit an existing component 248. If the decision is made not to edit an existing component, the brick and mortar retailer creates a new component 252. If the decision is made to edit an existing component, the brick and mortar retailer is offered choices as to which properties of the component to edit and the component property is changed 276. As previously described, in an embodiment, a component may have a text property, an image property, a link property and a background property a component. As will be apparent to those skilled in the art, a component may have any number of properties without departing from the scope of the present invention.

Whether a new component is created or an existing component is edited, the brick and mortar retailer is asked whether to save and/or upload the component and exit the program as previously described. (See FIG. 2, 228).

Referring again to FIG. 1, price folder 145 comprises prices of products offered by a brick and mortar retailer. In an embodiment of the present invention, the prices comprise a manufacturer suggested retail price (MSRP), a regular price and a sales price. For service products, the price further comprises an hourly rate. In an embodiment, the MSRP is obtained from the manufacturer data repository 150, the retailer data repository 155, the distributor data repository 160, or from any other available source of such data. As previously noted, price folder 145 may store the value of the price or may store a link to the price. Also as previously noted, a component of an EMA may have a link property that links to a price in the price folder 145.

According to an embodiment of the present invention, price folder 145 further comprises price limits established by the brick and mortar retailer. By way of illustration, the brick and mortar retailer may include a floor price for a product. The floor price may be expressed as an absolute number or as a percentage of the MSRP, regular or sales price. In this embodiment, only users with special privileges may create or change the floor price. In this way, the brick and mortar retailer is assured that the price presented to a consumer cannot be accidentally or maliciously changed below a certain value. In yet another embodiment, price folder 145 comprises an expiration date with respect to a price.

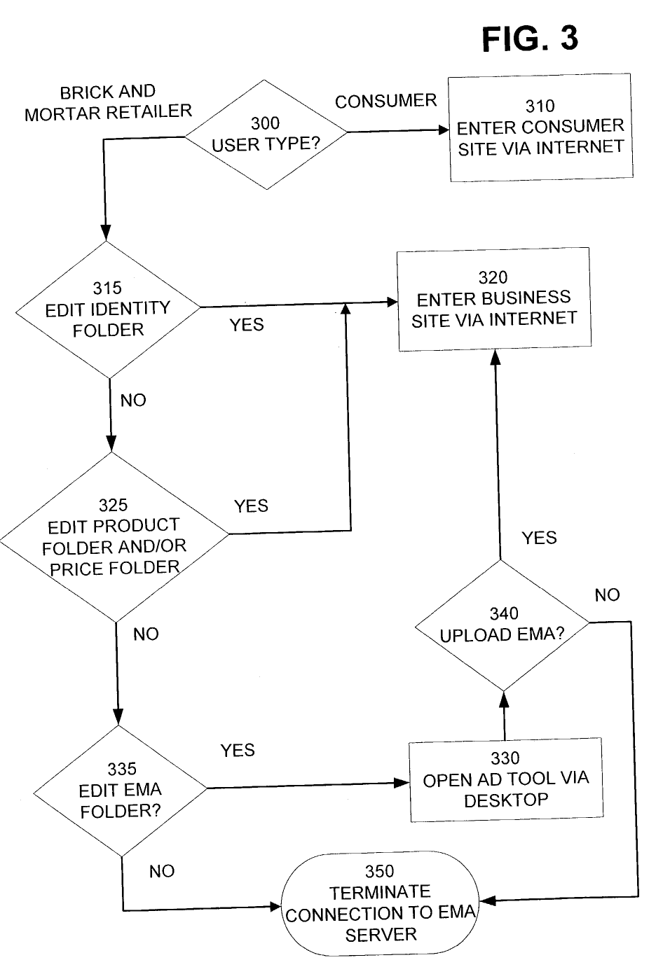

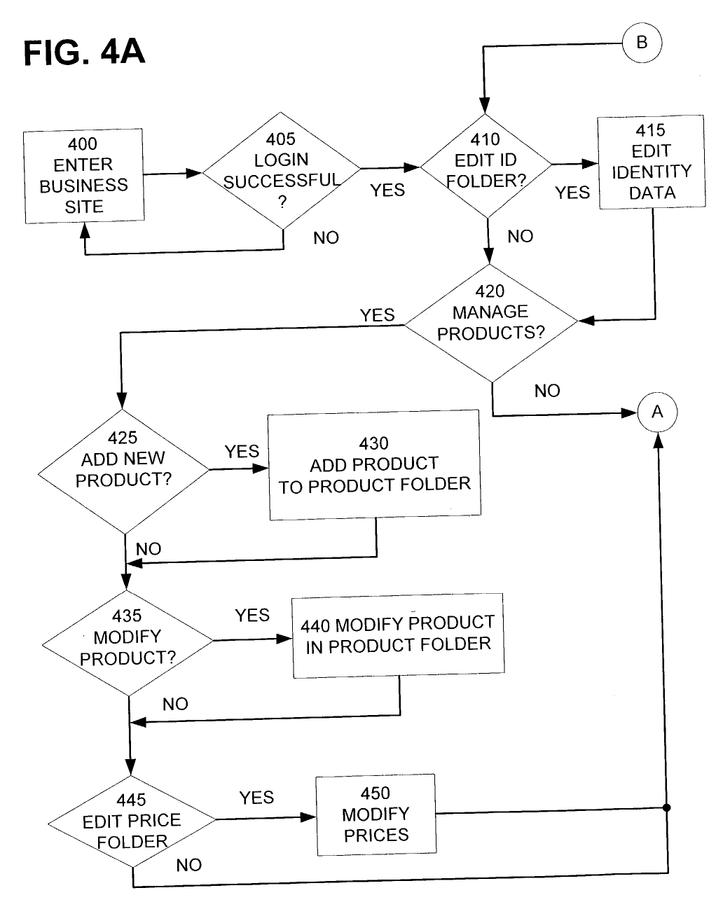

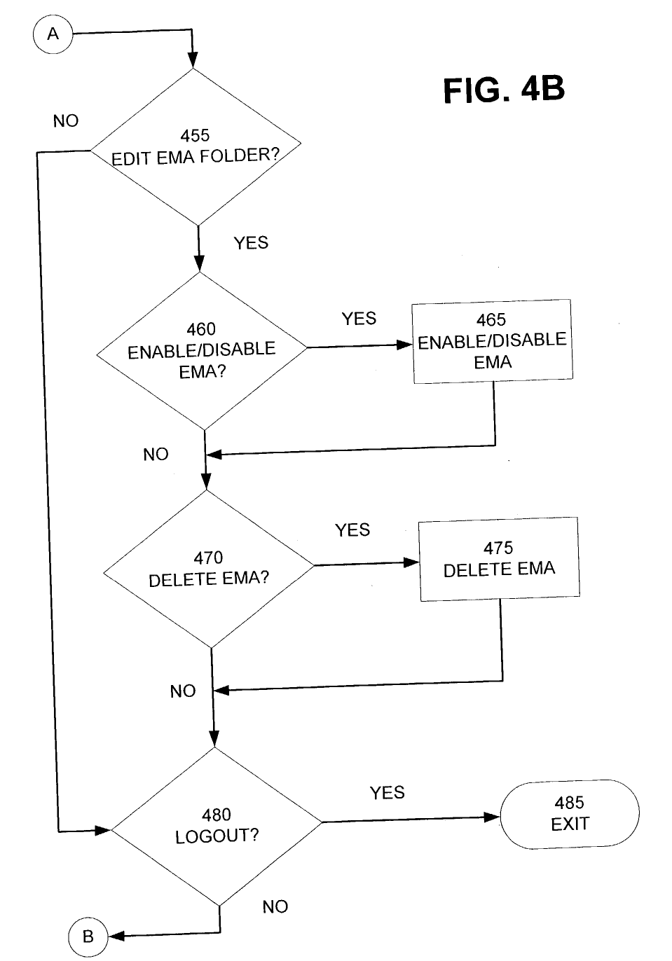

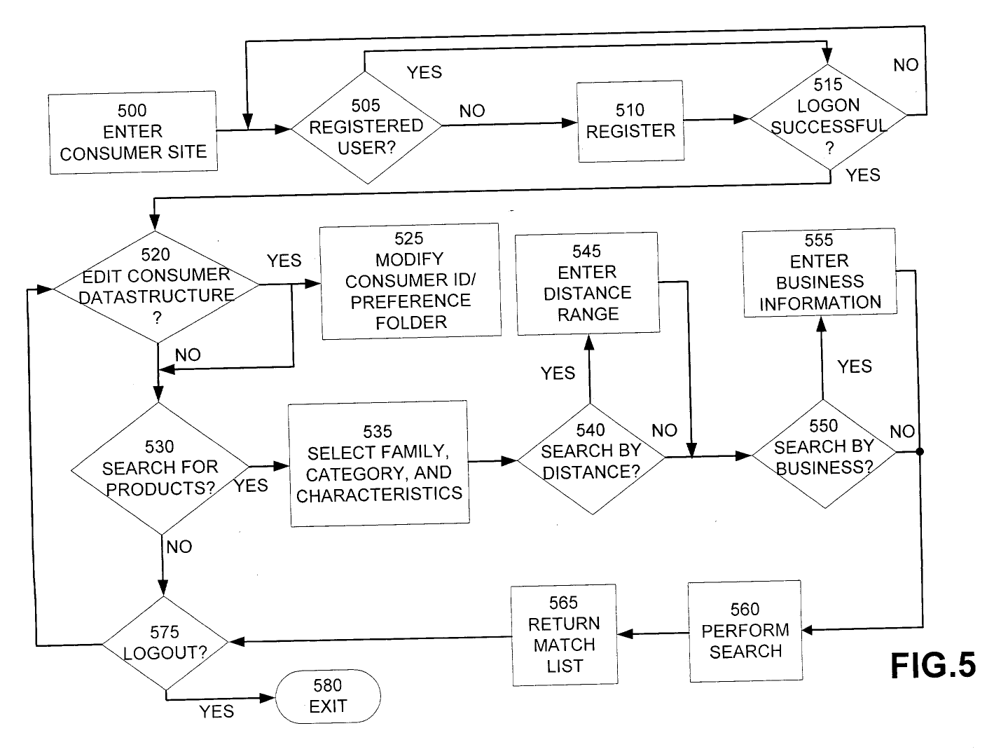

Both consumers and brick and mortar retailers may access the electronic media server. Referring to FIG. 3, a flow of an access process according to an embodiment of the present invention is illustrated. The user type is determined 300 and the flow is directed accordingly. If the user is a consumer, the consumer enters the consumer site through the Internet 310. The consumer site is described in reference to FIG. 5 below. If the user is a brick and mortar retailer, the brick and mortar retailer is given an opportunity to edit the identity folder 315 and edit the product folder and/or the price folder 325. If either or both of these options are selected, the brick and mortar retailer enters the business site via the Internet 320. The business site is described in reference to FIG. 4 below.

If the brick and mortar retailer elects not to edit the identity folder 315 or edit the product folder and/or the price folder 325, the brick and mortar retailer may elect to edit the EMA folder 335. If the brick and mortar retailer decides to edit the EMA folder, the Ad Tool (described in reference to FIG. 2) is opened 330. The brick and mortar retailer may elect to upload an EMA to the EMA folder (FIG.1, 140) from the Ad Tool 340. If the brick and mortar retailer elects to upload an EMA, the brick and mortar retailer enters the business site 320. If the brick and mortar retailer does not elect to edit the EMA folder 335 or to upload an EMA 340, the connection to the EMA server is terminated 350.

Referring to FIGS. 4A and 4B, a business site according to an embodiment of the present invention is illustrated. A brick and mortar retailer enters the business site 400 and attempts to logon. If the logon attempt is successful 405, the brick and mortar retailer is offered an opportunity to modify the identity folder (FIG. 1, 130) 410. If the brick and mortar retailer elects to edit the identity folder, the desired edits are made 415 in the data held in the identity folder. When the brick and mortar retailer is finished making edits to the identity data, or if the brick and mortar retailer elected not to edit the identity folder, the brick and mortar retailer is offered an opportunity to manage the product 420 of the brick and mortar retailer as stored in the BMR datastructure (FIG. 1, 125). The brick and mortar retailer may edit the product folder (FIG. 1, 135) by adding a new product (425-430), and/or by modifying a product offering (435-440). Additionally, the brick and mortar retailer may edit the price folder (FIG. 1, 145) to change, add, or delete a price (445-450). Upon completion of the desired management of product options, the brick and mortar retailer is offered the opportunity to edit the EMA folder 455. The brick and mortar retailer may edit the EMA folder by enabling or disabling an EMA (460-465) or by deleting an EMA (470-475). When the brick and mortar retailer is finished making edits to the EMA folder, or if the brick and mortar retailer elected not to edit the EMA folder, the brick and mortar retailer is offered an opportunity to logout 480. If the brick and mortar retailer elects to logout, the brick and mortar retailer exits the business site 485. Otherwise, the brick and mortar retailer is returned to the beginning of the flow 410.

Referring to FIG. 5, a consumer site according to an embodiment of the present invention is illustrated. A consumer enters the consumer site 500 and a determination is made if the consumer is a registered user 505. If the consumer is not a registered user, the consumer registers 510 with the consumer site.

Registration and login are well known in the art and can be accomplished by various means without departing from the scope of the present invention. Additionally, the privileges associated with registration can be varied to suit the application of the present invention. In an embodiment, registration is required to store a preference folder (FIG. 1, 175) within the consumer datastructure (FIG. 1, 165), but registration is not required to initiate a search request. It will be clear to those skilled in the art, that variations in privilege schemes described herein can be made without departing from the scope of the present invention.

The registered user attempts to logon and if the logon is successful 515, the consumer is given an opportunity to edit the consumer datastructure 520. (See, FIG. 1, 165.) If the consumer elects to edit the consumer datastructure, the consumer modifies the content of the consumer identity folder and/or the consumer preference folder 525. (See, FIG. 1, 170, 175.) When the consumer is finished making edits to the consumer datastructure, or if the consumer elected not to edit the consumer datastructure, the consumer is offered an opportunity to search for products 530. If the consumer elects to search for products, the consumer enters the product family, category and characteristics 535.

In an embodiment of the present invention, the electronic media server manages the search request through the use of a product hierarchy. To illustrate, the top of the product hierarchy is a product family (for example, appliances, transportation, clothing, insurance, and services). At the second tier of this hierarchy, each family is divided into product categories. For example, within the product family “appliances” are the product categories refrigerators, washers, dryers, and dishwashers. Within the product family “services” are the product categories plumbing services and dental services. Within the product family “insurance” are the product categories life insurance, home insurance and automobile insurance. The last level of the product hierarchy is the product characteristics associated with each product within a product category.

In another embodiment, in response to the search request, the electronic media server sends the user a product family drop-down list that is displayed on the user's UAD. The user selects the product family of interest and returns the selection to the electronic media server. The electronic media server responds by sending to the UAD a product category drop-down list and prompting the user to select a product category. The electronic media server replies to the selection made by the user by causing the UAD to display a product characteristic drop-down list. The product characteristics shown in the products characteristics drop-down list are a predetermined set of characteristics assigned to the product category selected by the user. In yet another embodiment, the consumer search request is performed using key words that are entered by the consumer.

The consumer may also elect to include distance parameters to the search request 540. If distance parameters are desired, the consumer enters them 545. In an embodiment of the present invention, distance parameters comprise the zip code where the user is interested in shopping, and if desired, a distance in miles outside that zip code that the user is willing to travel to purchase the item of interest. Additionally, the consumer may elect to search by a business type 550. If elected, business type parameters are added to the search request 555. A search is performed 560 and a match list returned 565 to the consumer. The consumer may logout 575 or return to the beginning of the flow 520.

In an embodiment of the present invention, the electronic media server searches the product directory (FIG. 1, 180) for products that match the product category identified in the search request and identifies each brick and mortar retailer that offers the product. The electronic media server further determines from the product directory (FIG. 1, 180) whether a brick and mortar retailer identified the product category has also uploaded an EMA to the EMA folder (FIG. 1, 140). If the brick and mortar retailer has uploaded one or more EMAs, the EMA folder (FIG. 1, 140) is also searched. If no additional search criteria were specified in the search request, the electronic media server returns a match list 565 of the brick and mortar retailers offering the product, and, if applicable, the EMAs for that category. If other criteria were specified, the electronic media server searches the product folders (FIG. 1, 135) and, if appropriate, other data repositories, associated with each brick and mortar retailer identified as offering the product for matches against the additional criteria. In an alternate embodiment, the electronic media server parses the EMAs stored in EMA folders on the central datastore (FIG. 1, 120) and searches the results for matches to the search criteria.

By way of example and without limitation, a user connects to the electronic media server and initiates a search request. From a product family drop-down list, the user selects “APPLIANCES”. From a product category drop-down list, the user selects “REFRIGERATORS”. By selecting refrigerators, the user is then given a product characteristic drop-down list. In the example, these characteristics include the manufacturer, dimensions, volume, style (side-by-side, top freezer, bottom freezer), features (water dispenser, ice maker, ice dispenser), color, and energy efficiency. The user receives a match list identifying the brick and mortar retailers that carry refrigerators matching some or all of the product characteristics selected by the user. If the brick and mortar retailer has uploaded one or more EMAs that match the product family or product category, the match list so indicates and includes means for displaying EMAs to the consumer.

The electronic media server also manages the match list resulting from a user initiated search request. In one embodiment, the electronic media server prioritizes the matches in the match list by sorting the match list such that those brick and mortar retailers that have uploaded EMAs ahead of those who have not. A further prioritization sorts the match list such that those brick and mortar retailers with EMAs that include pricing information are displayed ahead of those brick and mortar retailers with EMAs that do not include pricing information. Another prioritization sorts the match list such that the brick and mortar retailers with the best price on a matching product are displayed ahead of all other matches on the match list. These and other priority schemes for sorting the match list may be predetermined or selected by the user. As will be apparent to those skilled in the art, any number of priority schemes may be applied to the match list without departing from the scope of the present invention.

In an embodiment of the present invention, the consumer may transfer the results of a search request and selected EMAs to a portable electronic device (PED). By way of example, the PED may be a laptop computer, a cellular phone, or a personal digital assistant. However, this is not meant as a limitation. As will be apparent to those skilled in the art, any portable device that can accept and display digital data may be used in this embodiment without departing from the scope of the present invention. In this way, the consumer may have access to the product and sales information while away from a UAD.

In yet another embodiment, the electronic media server causes an identifier to be associated with a brick and mortar retailer that matches, or substantially matches, the product characteristics selected in a search request wherein that brick and mortar retailer's offered price is below the brick and mortar retailer's normal price (a “special price offering”). For example, if a user specifies a brand and a brick and mortar retailer is offering a competing brand at a special price offering, and the competing brand otherwise meets all of the other product characteristics selected by the user, an identifier (such as an icon or a flashing symbol) is associated with the brick and mortar retailer's name in the match list. Additionally, the electronic media server may be directed by a registered user to notify the registered user upon login of special price offerings by particular brick and mortar retailers by particular product or product category.

In another embodiment of the present invention, the product folder (FIG. 1, 135) of a brick and mortar retailer further comprises a current inventory list. In this embodiment, the consumer is able to determine not only if a brick and mortar retailer carries a particular product but also whether the product is in stock. In this variation of the present invention, the brick and mortar retailer's inventory list may include a link to the brick and mortar retailer to allow the user to reserve a item to ensure that the item will be at the brick and mortar retailer's store when the user arrives.

In still another embodiment, the central datastore (FIG. 1, 120) comprises BMR datastructures (FIG. 1, 125) for brick and mortar retailers located at a mall. The match list provided to a user initiated search request is thus limited to those brick and mortar retailers located within the mall. In an alternative embodiment, a consumer shopping at a mall uses a UAD situated at kiosk or, alternatively, use a wireless UADs loaned or rented by the mall.

In another embodiment, the brick and mortar retailer is a restaurant. In this embodiment, the product folder (FIG. 1, 135) comprises information relating to cuisine offered, hours that meals are served and, if desired, the menu with or without prices.

A system and method for directing information relating to a product offering of a retailer to a user over a network has been described. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

We claim:

1. A system for directing information relating to a product offering of a retailer to a user over a network, the system comprising:
a network;
a user access device connect to the network;
a central datastore comprising one or more retailer product folders, wherein each retailer product folder is associated with a retailer by a retailer identifier;
an electronic media server connected to the network, the electronic media server adapted to implement instructions for:
accessing a distributor data repository, wherein the distributor data repository comprises product data associating a product with a retailer that distributes the product, and wherein the product data comprises a product identifier and retailer information;
storing the product data in the retailer product folder associated with the retailer that distributes the product;
relating the product distributed by the retailer to a manufacturer that produced the product distributed by the retailer;
accessing a manufacturer data repository of the manufacturer, wherein the manufacturer data repository comprises manufacturer data associating the product distributed by the retailer with one or more product characteristics; and
storing manufacturer data in the retailer product folder of the retailer that distributes the product.

2. The system of claim 1, wherein the network is the Internet.

3. The system of claim 1, wherein the network is selected from the group consisting of a wired network, a wireless network, and a hybrid network.

4. The system of claim 1, wherein the user access device is a general purpose computer.

5. The system of claim 1, wherein the user access device is a selected from the group consisting of a personal data assistant, a laptop computer, and a wireless display device.

6. The system of claim 1, wherein retailer information comprises a retailer name, a retailer business address, and one or more retailer outlet addresses.

7. The system of claim 1, wherein the product identifier comprises a product class.

8. The system of claim 1, wherein the product identifier is a manufacturer product code selected from the group consisting of a universal product code and an EAN Article Numbering Code.

9. The system of claim 8, wherein relating the product distributed by the retailer to a manufacturer that produced the product distributed by the retailer comprises associating the manufacturer product code to a product assigned the manufacturer product code.

10. The system of claim 1, wherein storing the product data in the retailer product folder comprises storing in the retailer product folder a link to the product data in the retailer data repository.

11. The system of claim 1, wherein the one or more product characteristics include a brand name, manufacturer product code, a set of dimensions, a color, a weight, a volume, a power measurement, an energy efficiency rating, and a feature.

12. The system of claim 1, wherein accessing a distributor data repository comprises polling the distributor data repository.

13. The system of claim 1, wherein accessing a distributor data repository comprises responding to a prompt sent by the distributor data repository.

14. The system of claim 1, wherein accessing a manufacturer data repository comprises polling the manufacturer data repository.

15. The system of claim 1, wherein accessing a manufacturer data repository comprises responding to a prompt sent by the manufacturer data repository.

16. The system of claim 1, wherein storing manufacturer data in the retailer product folder of the retailer that distributes the product comprises storing the product characteristics in the retailer product folder associated with the retailer identifier.

17. The system of claim 1, wherein storing manufacturer data in the retailer product folder of the retailer that distributes the product comprises storing in the retailer product folder a link to the product characteristics in the manufacturer data repository.

18. The system of claim 1, wherein the electronic media server is further adapted to implement instructions for:
determining whether product data for a product associated with a retailer that distributes the product is stored in the product folder associated with that retailer; and
if a product data for a product associated with a retailer that distributes the product is not stored in the product folder associated with that retailer, storing the product data for that product in the in the product folder associated with that retailer.

19. The system of claim 1, wherein the electronic media server is further adapted to implement instructions for:
receiving from the retailer an electronic media advertisement (EMA), wherein the EMA comprises a product identifier;
associating the EMA with the retailer identifier; and
storing the electronic media advertisement in the retailer product folder.

20. The system of claim 19, wherein the EMA further comprises price data.

21. The system of claim 20, wherein the price data comprises a manufacturer suggested retail price, a retailer standard price, and a retailer sales price.

22. The system of claim 19, wherein the EMA further comprises a link to price data.

23. The system of claim 22, wherein the price data comprises a manufacturer suggested retail price, a retailer standard price, and a retailer sales price.

24. The system of claim 1, wherein the electronic media server is further adapted to implement instructions for:
receiving a product search request from a user, the product search request comprising a product identifier and a search criterion;
making a first determination whether the product identifier matches any of the product data stored in the one or more retailer product folders;
if the search criterion matches any of the product data stored in the one or more retailer product folders, making a second determination with respect to the retailer product folders identified in the first determination whether the search criterion matches any of the manufacturer data; and
if the search criterion matches any of the manufacturer data stored in the one or more retailer product folders, directing the product data and manufacturing data stored in the one or more retailer product folders identified in the second determination to the user access device.

25. The system of claim 24, wherein the electronic media server is further adapted to implement instructions for:
if the search criterion matches any of the manufacturer data stored in the one or more retailer product folders, receiving from the user a request to transfer the product data and manufacturing data identified in the second determination to a portable electronic device (PED);
formatting the product data and manufacturing data stored in the one or more retailer product folders identified in the second determination for the PED identified in the transfer request; and
sending the product data and manufacturing data stored in the one or more retailer product folders identified in the second determination to the PED.

26. The system of claim 25, wherein the PED is selected from the group consisting of a laptop computer, a personal digital assistant, and a wireless telephone.

27. The system of claim 24, wherein the electronic media server is further adapted to implement instructions for:
making a third determination whether an EMA is stored in the one or more retailer product folders identified in the second determination;
if an EMA is stored in the one or more retailer product folders identified in the second determination, making a fourth determination whether the product identifier of the EMA matches the product identifier of the search request; and
if the product identifier of the EMA matches the product identifier of the search request, directing the EMA to the user access device.

28. The system of claim 27, wherein the electronic media server is further adapted to implement instructions for:
if the product identifier of the EMA matches the product identifier of the search request, receiving from the user a request to transfer the EMA to a portable electronic device (PED);
formatting the EMA for the PED identified in the transfer request; and
sending EMA to the PED.

29. The system of claim 28, wherein the PED is selected from the group consisting of a laptop computer, a personal digital assistant, and a wireless telephone.

30. A method for directing information relating to a product offering of a retailer to a user over an electronic media system, wherein the electronic media system comprises a network, a user access device, an electronic media server, and a central datastore, and wherein the central datastore comprising one or more retailer product folders, wherein each retailer product folder is associated with a retailer by a retailer identifier, the method comprising;
accessing a distributor data repository, wherein the distributor data repository comprises product data associating a product with a retailer that distributes the product, and wherein the product data comprises a product identifier and retailer information;
storing the product data in the retailer product folder associated with the retailer that distributes the product;
relating the product distributed by the retailer to a manufacturer that produced the product distributed by the retailer;
accessing a manufacturer data repository of the manufacturer, wherein the manufacturer data repository comprises manufacturer data associating the product distributed by the retailer with one or more product characteristics; and
storing manufacturer data in the retailer product folder of the retailer that distributes the product.

31. The method for directing information relating to a product offering of a retailer to a user over an electronic media system of claim 30, wherein the network is the Internet.

32. The method for directing information relating to a product offering of a retailer to a user over an electronic media system of claim 30, wherein the network is selected from the group consisting of a wired network, a wireless network, and a hybrid network.

33. The method for directing information relating to a product offering of a retailer to a user over an electronic media system of claim 30, wherein the user access device is a general purpose computer.

34. The method for directing information relating to a product offering of a retailer to a user over an electronic media system of claim 30, wherein the user access device is a selected from the group consisting of a personal data assistant, a laptop computer, and a wireless display device.

35. The method for directing information relating to a product offering of a retailer to a user over an electronic media system of claim 30, wherein retailer information comprises a retailer name, a retailer business address, and one or more retailer outlet addresses.

36. The method for directing information relating to a product offering of a retailer to a user over an electronic media system of claim 30, wherein the product identifier comprises a product class.

37. The method for directing information relating to a product offering of a retailer to a user over an electronic media system of claim 30, wherein the product identifier is a manufacturer product code selected from the group consisting of a universal product code and an EAN Article Numbering Code.

38. The method for directing information relating to a product offering of a retailer to a user over an electronic media system of claim 37, wherein relating the product distributed by the retailer to a manufacturer that produced the product distributed by the retailer comprises associating the manufacturer product code to a product assigned the manufacturer product code.

39. The method for directing information relating to a product offering of a retailer to a user over an electronic media system of claim 30, wherein storing the product data in the retailer product folder comprises storing in the retailer product folder a link to the product data in the retailer data repository.

40. The method for directing information relating to a product offering of a retailer to a user over an electronic media system of claim 30, wherein the one or more product characteristics include a brand name, manufacturer product code, a set of dimensions, a color, a weight, a volume, a power measurement, an energy efficiency rating, and a feature.

41. The method for directing information relating to a product offering of a retailer to a user over an electronic media system of claim 30, wherein accessing a distributor data repository comprises polling the distributor data repository.

42. The method for directing information relating to a product offering of a retailer to a user over an electronic media system of claim 30, wherein accessing a distributor data repository comprises responding to a prompt sent by the distributor data repository.

43. The method for directing information relating to a product offering of a retailer to a user over an electronic media system of claim 30, wherein accessing a manufacturer data repository comprises polling the manufacturer data repository.

44. The method for directing information relating to a product offering of a retailer to a user over an electronic media system of claim 30, wherein accessing a manufacturer data repository comprises responding to a prompt sent by the manufacturer data repository.

45. The method for directing information relating to a product offering of a retailer to a user over an electronic media system of claim 30, wherein storing manufacturer data in the retailer product folder of the retailer that distributes the product comprises storing the product characteristics in the retailer product folder associated with the retailer identifier.

46. The method for directing information relating to a product offering of a retailer to a user over an electronic media system of claim 30, wherein storing manufacturer data in the retailer product folder of the retailer that distributes the product comprises storing in the retailer product folder a link to the product characteristics in the manufacturer data repository.

47. The method for directing information relating to a product offering of a retailer to a user over an electronic media system of claim 30, wherein the electronic media server is further adapted to implement instructions for:
determining whether product data for a product associated with a retailer that distributes the product is stored in the product folder associated with that retailer; and
if a product data for a product associated with a retailer that distributes the product is not stored in the product folder associated with that retailer, storing the product data for that product in the in the product folder associated with that retailer.

48. The method for directing information relating to a product offering of a retailer to a user over an electronic media system of claim 30, wherein the electronic media server is further adapted to implement instructions for:
receiving from the retailer an electronic media advertisement (EMA), wherein the EMA comprises a product identifier;
associating the EMA with the retailer identifier; and
storing the electronic media advertisement in the retailer product folder.

49. The method for directing information relating to a product offering of a retailer to a user over an electronic media system of claim 48, wherein the EMA further comprises price data.

50. The method for directing information relating to a product offering of a retailer to a user over an electronic media system of claim 49, wherein the price data comprises a manufacturer suggested retail price, a retailer standard price, and a retailer sales price.

51. The method for directing information relating to a product offering of a retailer to a user over an electronic media system of claim 48, wherein the EMA comprises a link to price data.

52. The method for directing information relating to a product offering of a retailer to a user over an electronic media system of claim 51, wherein the price data comprises a manufacturer suggested retail price, a retailer standard price, and a retailer sales price.

53. The method for directing information relating to a product offering of a retailer to a user over an electronic media system of claim 30, wherein the electronic media server is further adapted to implement instructions for:
receiving a product search request from a user, the product search request comprising a product identifier and a search criterion;
making a first determination whether the product identifier matches any of the product data stored in the one or more retailer product folders;
if the search criterion matches any of the product data stored in the one or more retailer product folders, making a second determination with respect to the retailer product folders identified in the first determination whether the search criterion matches any of the manufacturer data; and
if the search criterion matches any of the manufacturer data stored in the one or more retailer product folders, directing the product data and manufacturing data stored in the one or more retailer product folders identified in the second determination to the user access device.

54. The method for directing information relating to a product offering of a retailer to a user over an electronic media system of claim 53, wherein the electronic media server is further adapted to implement instructions for:
if the search criterion matches any of the manufacturer data stored in the one or more retailer product folders, receiving from the user a request to transfer the product data and manufacturing data identified in the second determination to a portable electronic device (PED);
formatting the product data and manufacturing data stored in the one or more retailer product folders identified in the second determination for the PED identified in the transfer request; and
sending the product data and manufacturing data stored in the one or more retailer product folders identified in the second determination to the PED.

55. The system of claim 54, wherein the PED is selected from the group consisting of a laptop computer, a personal digital assistant, and a wireless telephone.

56. The method for directing information relating to a product offering of a retailer to a user over an electronic media system of claim 53, wherein the electronic media server is further adapted to implement instructions for:
making a third determination whether an EMA is stored in the one or more retailer product folders identified in the second determination;
if an EMA is stored in the one or more retailer product folders identified in the second determination, making a fourth determination whether the product identifier of the EMA matches the product identifier of the search request; and
if the product identifier of the EMA matches the product identifier of the search request, directing the EMA to the user access device.

57. The system of claim 56, wherein the electronic media server is further adapted to implement instructions for:
if the product identifier of the EMA matches the product identifier of the search request, receiving from the user a request to transfer the EMA to a portable electronic device (PED);
formatting the EMA for the PED identified in the transfer request; and
sending EMA to the PED.

58. The system of claim 57, wherein the PED is selected from the group consisting of a laptop computer, a personal digital assistant, and a wireless telephone.

59. A method for creating a dynamic electronic media advertisement wherein the dynamic media advertisement comprises one or more layers, and wherein a layer comprises one more components, the method comprising:
creating one or more layers, wherein each layer is assigned a layer number in order of its creation;
assigning to at least one of the one or more components a linked property, wherein a value of the linked property is associated with the linked property though a link; and stacking the one or more dynamic layers in order of the layer number.

60. The method for creating a dynamic electronic media advertisement of claim 59, wherein the link comprises a location in a datastructure and wherein the value of the linked property is stored at the location.

61. The method for creating a dynamic electronic media advertisement of claim 60, the method further comprising assigning the value to the linked property by storing the value at the location.

62. The method for creating a dynamic electronic media advertisement of claim 60, wherein the linked property is an image and the image value is stored at the location.

63. The method for creating a dynamic electronic media advertisement of claim 60, wherein the linked property is a text block and the text block value is stored at the location.
